(19) United States
(12) Patent Application Publication
(10) Pub. No.: US 2009/0233112 A1
(43) Pub. Date: Sep. 17, 2009

(54) MULTILAYER ZINC OXIDE VARISTOR

(76) Inventors: Shih-Kwan Liu, Hsinchu City (TW); Hui-Ming Feng, Jhongli City (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/047,335

(22) Filed: Mar. 13, 2008

(51) Int. Cl. B32B 15/04

(52) U.S. Cl. 428/472; 428/469

(57) ABSTRACT

Enclosed is a multilayer zinc oxide (ZnO) varistor having a body portion, internal electrodes extending from both sides to the interior of the body portion respectively, and terminal electrodes disposed at both sides of the body portion. The multilayer zinc oxide is characterized in that: the components of said body portion include at least 90 mole % ZnO, 0.1 to 5.0 mole % antimony oxide functional additives, 0.01 to 1.0 mole % praseodymium oxide functional additives, and 0.01 to 10.0 wt. % glass; the sum amount of these metal oxides is less than 99.95 mole %.

### BACKGROUND OF THE INVENTION

1. Field of the Invention

The present invention relates to a multilayer varistor, particularly to a multilayer zinc oxide (ZnO) varistor wherein the major component of the body portion is zinc oxide (ZnO).

2. Description of the Prior Art

As generally known, the structure of a multilayer varistor, as shown in FIGS. 1 and 2, includes a body portion 10, internal electrodes 101, 102, 103 . . . extended from both sides to the interior of the body portion 10, a terminal electrode 20 disposed at both sides of the body portion, and a cover layer 30 which may (or may not) be disposed on the top side of the body, wherein more than 90 mole % ZnO is used in the body portion as the major component mixed with less than 10 mole % metal oxide functional additive compounds, such as Co, Mn, C, Ni, Ti, Sn, La, Nd, Ba, Mg, Ce, and B. Flux such as Al₂(NO₃)ₓ, glass and SiO₂ may or may not be used. Metals such as Au, Ag, Pd, Pt, Rh or any two of these metals can be used as internal electrodes 101 . . . . The breakdown voltage of said multilayer varistor can be adjusted by means of design.

Generally, voltages or currents in power circuits or signal circuits are inevitably increased all at once. Such increase in voltages or currents is called “surge”. The surge usually occurs due to flashing lightning or instant switching On/Off electric devices, which may damage electric devices or even lead to fire threats. A varistor, also can be called as surge absorbers, is frequently used as the protective device for electric circuits or electric devices to protect them from surges damage and ensure the normal operation of electric circuits or electric devices.

Recently, with the variety of functions in handheld devices such as mobile phones and PDA and the increasing complexity of internal circuit design, the necessity for electrical static discharge protection is gradually increased.

Accordingly, the zinc oxide (ZnO) based multilayer varistor has been widely applied to electrical static discharge protection.

The material systems of said conventional multilayer zinc oxide (ZnO) varistor are described as follows:
1. BiO₂-containing oxide additives which are characterized in the use of glass as a flux. One example is U.S. Pat. No. 5,369,390 filed by Materials Research Laboratories, ITRI of Taiwan. Generally, the sintering temperature of this material system can be around 1100° C. Therefore, the low cost Ag or Ag/Pd alloy can be used as the material for internal electrodes.
2. Similar to the material system above, BiO₂-containing oxide additives without glass added as a flux. Other special additives are used instead to lower sintering temperature. One example is Taiwan Patent No. 593205 filed by YAGEO CORP.
3. Similar to the material system above, BiO₂-containing oxide additives without flux or special additives. High temperature (above 1200° C.) is used for sintering. At this time, materials with melting point above 1200° C. such as 100% Pt, 100% Pd or high Pd content (>40%) noble metals should be used as internal electrodes. Both manufacture and material costs of such multilayer varistor are high.
4. Praseodymium oxide (Pr₆O₁₁)-containing oxide additives which usually comprise CoO, Co₃O₄, Y₂O₃ etc. and is characterized in: glass is not used as a flux, while BiO and other flux or special additives are not used. Similarly, materials with melting point above 1200° C. such as 100% Pt, 100% Pd or high Pd content (>40%) noble metals should be used as internal electrodes so that the sintering process with sintering temperature at 1200 to 1400° C. can be implemented. Therefore, both manufacture and material costs are high.

Generally, the surge sustainability of system 1 and system 2 is good. However, the electrical static discharge sustainability is poor when the systems are used to manufacture low breakdown voltage (below 22V) devices.

Both surge sustainability and electrical static discharge sustainability of system 3 are good. However, the cost is high due to the use of 100% Pt or 100% Pd as internal electrodes and high sintering temperature.

Both surge sustainability and electrical static discharge sustainability of system 4 are good. Similar to system 3, 100% Pt or 100% Pd is required to use as internal electrodes, which leads to high costs. Furthermore, the system 4 has deficiency in its material characteristic when it is used to manufacture “low breakdown voltage (below 10V)” and “low capacitance (below 50 pF)” devices.

Accordingly, the present invention has been made to solve the above-mentioned problem occurring in the conventional multilayer varistor.

### SUMMARY OF THE INVENTION

The present invention is then to provide a multilayer varistor. The body portion in the multilayer varistor according to the present invention comprises at least praseodymium oxide and antimony oxide and the other two metal oxide functional additives so that the breakdown voltage of the multilayer varistor can be reduced, the intensity as well as the electrical static discharge sustainability can be enhanced. This is the primary objective of the present invention.

The multilayer varistor according to the present invention needs to operate in coordination with glass as flux. Therefore, lower sintering temperature can be employed for sintering and metal materials with cost lower than conventional ones can be used as internal electrodes. This is the second objective of the present invention.

A more complete understanding of these and other features and advantages of the present invention will become apparent from a careful consideration of the following detailed description of certain embodiments illustrated in the accompanying drawings.

### BRIEF DESCRIPTION OF THE DRAWINGS

FIG. 1 is a partial cross-sectional three-dimensional view showing the structure of multilayer varistor.

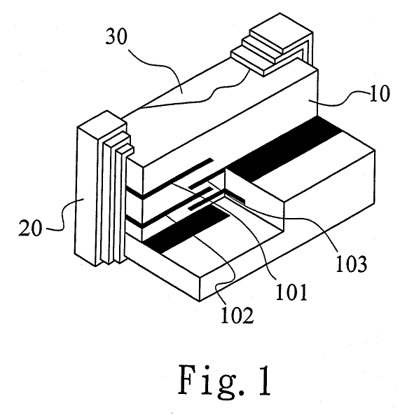

FIG. 2 is a vertical cross-sectional view of the multilayer varistor.

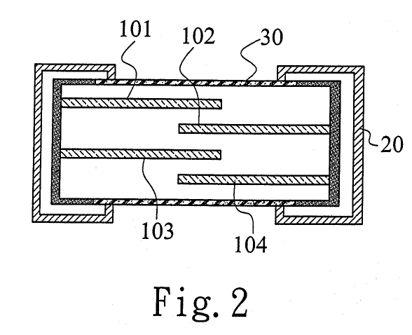

### DETAILED DESCRIPTION OF THE PREFERRED EMBODIMENTS

In the multilayer zinc oxide (ZnO) varistor according to the present invention, the basic materials used in the body portion include: at least 90 mole % of ZnO and at most 10 mole % of functional additive compounds, while the total amount of them is less than or equal to 99.95 mole %; which serves as the basis for constructing the body portion of a multilayer zinc oxide (ZnO) varistor. Said functional additives are composed of praseodymium oxide and antimony oxide and at least two of the following metal oxides: Co, Mn, Cr, Ni, Ti, Sn, La, Nd, Ba, Mg, Ce, B. Meanwhile, the body portion includes 0.1 to 5.0 mole % of antimony oxide, 0.01 to 1.0 mole % of praseodymium oxide, and 0.1 to 10.0 wt. % of glass (calculation formula: glass weight/total oxide weight×100%). In addition to glass, the raw materials of the body portion have at least 99% purity.

The types and contents of glass are shown in the following table 1:

wt. %

| | PbO | B₂O₃ | ZnO | SiO₂ |
|---|---|---|---|---|
| A | 61 | 18 | 0 | 31 |
| B | 0 | 30 | 58 | 12 |
| C | 0 | 25 | 65 | 10 |
| D | 62 | 20 | 10 | 8 |

### EXAMPLE

The above-described raw materials in the proper ratio are put into a ball mill pot. The materials are dispersedly grinded by using the deionized water and ball mill. The mixed ball mill is dried by heat after 16 to 24 hrs and then becomes slurry. The slurry includes properly dried oxide powders, glass, binder, dispersant, plasticizer and releasing agent. Then tape casting is used for the slurry to form a green tape having a thickness of 20 μm to 200 μm on a release film. Afterwards, the designed internal electrode patterns are formed on the green tape. Said internal electrodes can be composed of 100% Ag, or Ag/Pd mixed powder, or Ag/Pd alloy. The Pd content in the mixed Ag/Pd metal powder or Ag/Pd alloy is 0 to 50 wt. %. Thereafter, the materials are stacked and formed by using the conventional multilayer device manufacturing process. After the debinder treatment, the materials are sintered at the temperature below 1200° C. The highest sintering temperature lasts about 1 to 8 hr.

As described above, the multilayer varistor according to the present invention has virtues including high intensity, low breakdown voltage, simple manufacturing and low cost which can improve the shortage of conventional multilayer varistors. Also, the present invention has not yet been publicly used, which is consistent with relevant Patent Law.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A multilayer zinc oxide (ZnO) varistor, wherein the components of its body portion include at least 90 mole % of ZnO and at most 10 mole % of praseodymium oxide and antimony oxide, other functional additives and 0.1˜10.0 wt. % of glass; the sum amount of these metal oxides is less than 99.95 mole %.

2. The multilayer zinc oxide (ZnO) varistor as claimed in claim 1, wherein the amount of antimony oxide is 0.1 to 5.0 mole % of the body portion.

3. The multilayer zinc oxide (ZnO) varistor as claimed in claim 1, wherein the amount of praseodymium oxide is 0.01 to 1.0 mole % of the body portion.

4. The multilayer zinc oxide (ZnO) varistor as claimed in claim 1, wherein the thickness between two internal electrodes is 5 to 200 μm.

5. The multilayer zinc oxide (ZnO) varistor as claimed in claim 1, wherein said other functional additives include at least two of the following metal oxides: Co, Mn, Cr, Ni, Ti, Sn, La, Nd, Ba, Mg, Ce, and B.

6. The multilayer zinc oxide (ZnO) varistor as claimed in claim 1, wherein said internal electrodes are composed of 100% Ag.

7. The multilayer zinc oxide (ZnO) varistor as claimed in claim 6, wherein said internal electrodes are composed of Ag/Pd mixed metal.

8. The multilayer zinc oxide (ZnO) varistor as claimed in claim 6, wherein said internal electrodes are composed of Ag/Pd metal alloy.

9. The multilayer zinc oxide (ZnO) varistor as claimed in claim 7, wherein the Pd content in the Ag/Pd alloy is 0 to 40 wt. %.

10. The multilayer zinc oxide (ZnO) varistor as claimed in claim 8, wherein the Pd content in the Ag/Pd alloy is 0 to 40 wt. %.

11. The multilayer zinc oxide (ZnO) varistor as claimed in claim 1, wherein the sintering temperature is 900 to 1200° C. the highest temperature can last about 40 mins to 8 hrs.
